(19) United States
(12) Patent Application Publication
(10) Pub. No.: US 2007/0277889 A1
(43) Pub. Date: Dec. 6, 2007

(54) Mixing valve

(76) Inventor: Michael Scot Rosko, Greenwood, IN (US)

Correspondence Address: BAKER & DANIELS LLP, 300 NORTH MERIDIAN STREET, SUITE 2700, INDIANAPOLIS, IN, 46204, US

(21) Appl. No.: 11/444,228

(22) Filed: May 31, 2006

(51) Int. Cl. F16K 11/078

(52) U.S. Cl. 137/625.4

(57) ABSTRACT

A fluid control valve for controlling the delivery of water includes a control stem that is movable by rotation of the control stem about two independent axes, and which is configured to control operation of a movable plate having an outer peripheral edge configured to control the flow of fluid through a plurality of fluid passageways.

### BACKGROUND AND SUMMARY OF THE INVENTION

The present invention relates generally to fluid control valves and, more particularly, to a mixing valve for use within a faucet.

Single-handle water faucet control valves are well known in the art and have been offered with different mechanical structures for controlling the available directions of travel, the ranges of motion, and the type or style of motion for the handle. One such known style of control valve includes a handle that is moved in a generally sideways (left-to-right and right-to-left) direction in order to adjust the mix of hot and cold water for a desired temperature. With this style of water faucet valve control arrangement, the handle is typically moved in an upward or forward direction, away from the user, to increase the flow rate and the volume of water delivered. The handle is typically moved in a downward or rearward direction, toward the user, in order to reduce the flow rate and volume of water, or to completely shut off the flow of water delivered from the faucet.

Known single-handled control valves are often referred to as having a joy stick control handle due to the single-handle construction and the manner in which the handle may be moved. The directions and ranges of motion are controlled by the internal structure of the valve mechanism and by the selection and arrangement of the component parts. It is further known to provide a water faucet control valve that is constructed and arranged to independently control the temperature and the flow rate of the water delivered to a use location by a single-handle or control lever. An illustrative example of such a known faucet control valve is described in U.S. Pat. No. 6,920,899, which is assigned to Masco Corporation of Indiana and the disclosure of which is expressly incorporated by reference herein.

According to an illustrative embodiment of the present invention, a fluid control valve includes a valve body defining a chamber and a plurality of passageways in fluid communication with the chamber. A valve device is positioned within the chamber and includes a movable plate having an outer peripheral edge configured to control the flow of fluid through the plurality of passageways. A movable spindle is operably coupled to the valve device. The spindle is configured to rotate in a first direction about a first axis for moving the movable plate within a first range of movement to control a first fluid flow parameter, and to rotate in a second direction about a second axis for moving the movable plate within a second range of movement to control a second fluid flow parameter. The first direction is distinct from the second direction, and the first axis is orthogonal to the second axis. The movable plate is configured to control the first fluid flow parameter and the second fluid flow parameter independently from each other throughout both the first range of movement and the second range of movement.

According to a further illustrative embodiment, a fluid control valve includes a valve body defining a chamber and a plurality of passageways in fluid communication with the chamber. A valve device is positioned within the chamber and includes a movable plate having an outer peripheral edge configured to control the flow of fluid through the plurality of passageways. A control stem is operably coupled to the movable plate and extends upwardly therefrom. An upper housing includes a guide member having a control opening through which the control stem passes. The control opening includes four walls disposed at substantially right angles to each other and defining a rectangle. The four walls include a rear wall, a front wall, a right wall, and a left wall. The valve device is in an off position when the control stem abuts the front wall of the control opening, the valve device is in a full-flow-on position when the control stem abuts the rear wall of the control opening, the valve device is in a cold-flow position when the control stem abuts the right wall of the control opening, and the valve device is in a hot-flow position when the control stem abuts the left wall of the control opening.

According to yet another illustrative embodiment, a fluid control valve includes a valve body defining a chamber, a hot water inlet, a cold water inlet, and an outlet. A bottom plate is received within the chamber and includes a hot water opening in fluid communication with the hot water inlet, and a cold water opening in fluid communication with the cold water inlet. A top plate is received within the chamber of the valve body, and includes an upper surface and a lower surface. The lower surface of the top plate is positioned in engagement with the upper surface of the bottom plate. The top plate is configured to provide selective fluid communication between the hot water opening and the chamber, and the cold water opening and the chamber. Water flowing through the hot water opening and the cold water opening is discharged to the outlet of the valve body by passing through the chamber. A movable spindle is operably coupled to the top plate. The spindle is configured to rotate about a first axis to cause sliding movement of the top plate relative to the bottom plate in a first direction, and to rotate about a second axis to cause sliding movement of the top plate relative to the bottom plate in a second direction. The first axis is orthogonal to the second axis, and the top plate is constrained to move within a rectangular boundary relative to the bottom plate.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a faucet including an illustrative embodiment fluid control valve of the present disclosure;

FIG. 2 is a perspective view of the fluid control valve configured to be received within the faucet of FIG. 1;

FIG. 3 is an exploded perspective view of the fluid control valve of FIG. 2;

FIG. 4 is a partial top exploded perspective view of the fluid control valve of FIG. 2;

FIG. 5 is a partial bottom exploded perspective view of the fluid control valve of FIG. 2;

FIG. 6 is an exploded perspective view of a first illustrative embodiment carrier, top plate, and bottom plate of the fluid control valve;

FIG. 7 is an exploded perspective view of a second illustrative embodiment carrier, and bottom plate of the fluid control valve, where the top plate is incorporated within the carrier;

FIG. 8 is a cross-sectional view taken along line 8-8 of FIG. 2;

FIG. 9 is a cross-sectional view of the valve body taken along line 9-9 of FIG. 2, showing the bottom plate positioned in spaced relation to the sealing seats;

FIG. 10A is a top plan view of the fluid control valve of FIG. 2, showing the control stem abutting a front wall of the control opening;

FIG. 10B is a diagrammatic view showing the valve device in an off position corresponding to the control stem position of FIG. 10A;

FIG. 11A is a top plan view similar to FIG. 10A, showing the control stem abutting a rear wall of the control opening;

FIG. 11B is a diagrammatic view showing the valve device in a full-flow-on position corresponding to the control stem position of FIG. 11A;

FIG. 12A is a top plan view similar to FIG. 10A, showing the control stem abutting a left wall of the control opening;

FIG. 12B is a diagrammatic view showing the valve device in a hot-flow position corresponding to the control stem position of FIG. 12A;

FIG. 13A is a top plan view similar to FIG. 10A, showing the control stem abutting a right wall of the control opening; and

FIG. 13B is a diagrammatic view showing the valve device in a cold-flow position corresponding to the control stem position of FIG. 13A.

### DETAILED DESCRIPTION OF THE DRAWINGS

The embodiments of the invention described herein are not intended to be exhaustive or to limit the invention to precise forms disclosed. Rather, the embodiment selected for description have been chosen to enable one skilled in the art to practice the invention. Although the disclosure is described in connection with water, it should be understood that additional types of fluids may be substituted therefor.

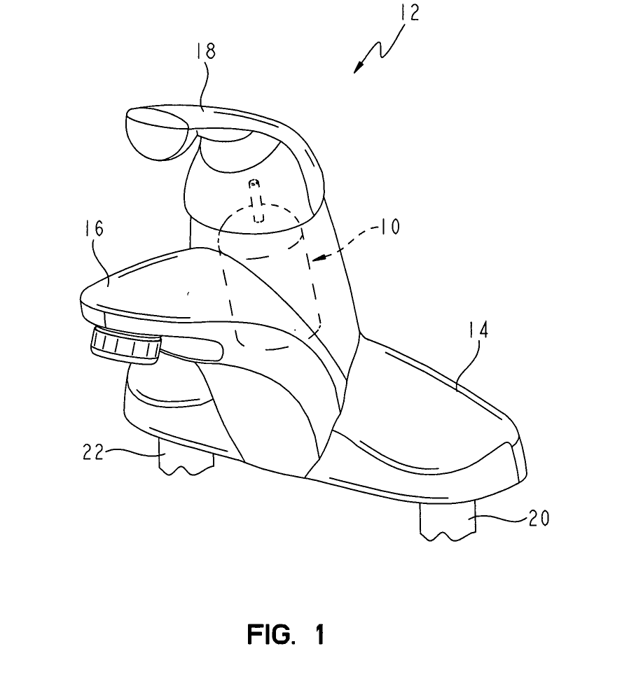

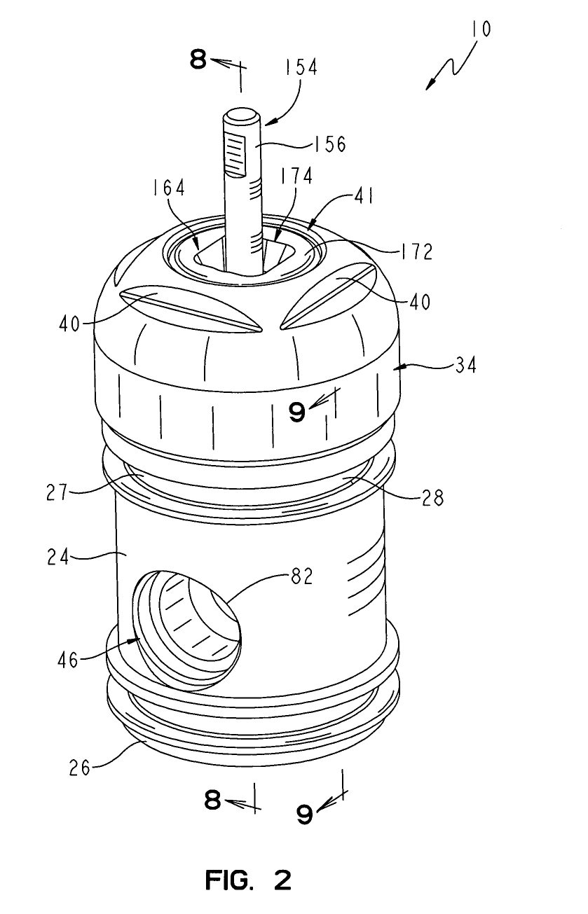

Referring initially to FIGS. 1 and 2, an illustrative embodiment fluid control valve 10 is shown as being received within a conventional faucet 12. Illustratively, the faucet 12 includes a base 14 supporting a delivery spout 16 and a control handle 18. As is known in the art, a cold water supply conduit 20 and a hot water supply conduit 22 are fluidly coupled to the control valve 10. The cold water supply conduit 20 and the hot water supply conduit 22 are configured to be coupled to a cold water supply and a hot water supply, respectively. Operation of the control valve 10 determines the temperature and the flow rate of the water supplied to the delivery spout 16 from the conduits 20 and 22.

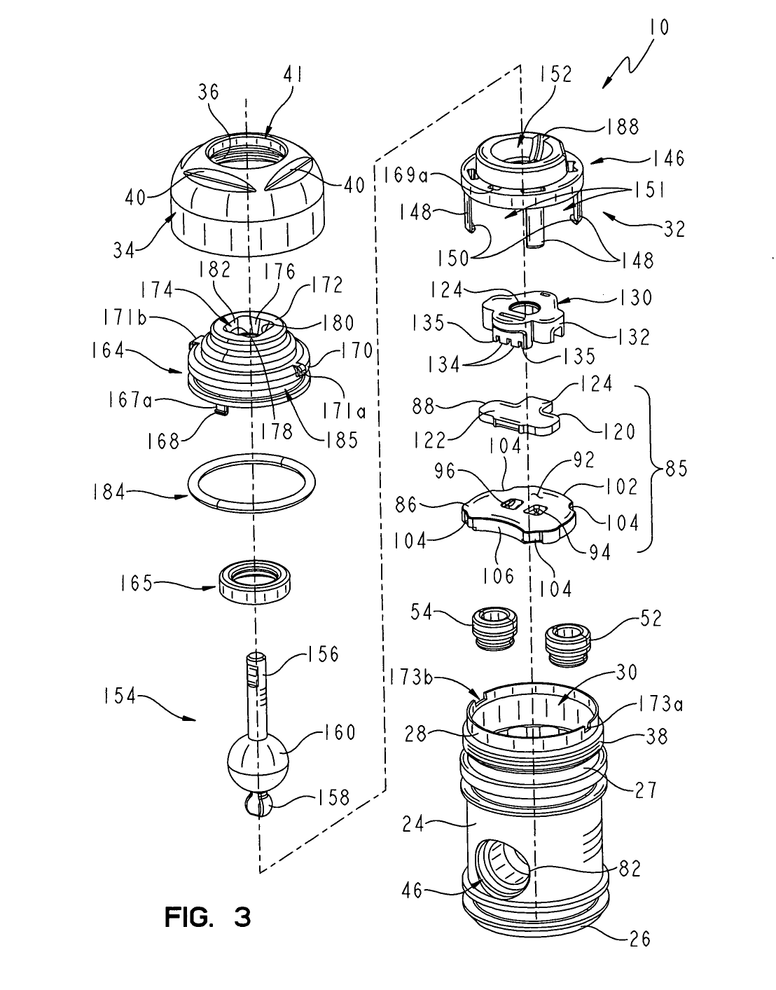

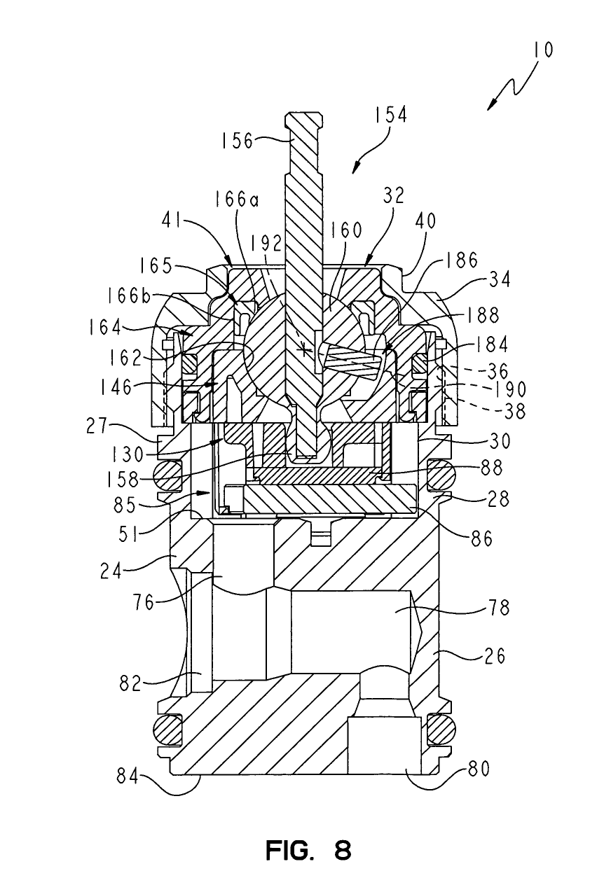

With reference to FIGS. 2-5, 8 and 9, fluid control valve 10 includes a valve body 24 having a lower portion or base 26 and an upper portion 27 having upwardly extending cylindrical side wall 28. The valve body 24 defines an interior chamber 30 configured to receive a flow control assembly 32. A bonnet nut 34 includes a plurality of internal threads 36 which are configured to engage a plurality of external threads 38 supported proximate an upper end of the valve body 24 (FIGS. 3 and 8). The bonnet nut 34 illustratively includes a plurality of flats 40 configured to be engaged by a tool, thereby facilitating rotation onto the valve body 24. The bonnet nut 34 further includes a central opening 41 formed in an upper end thereof. Both the valve body 24 and the bonnet nut 34 may be formed of a conventional material, such as brass.

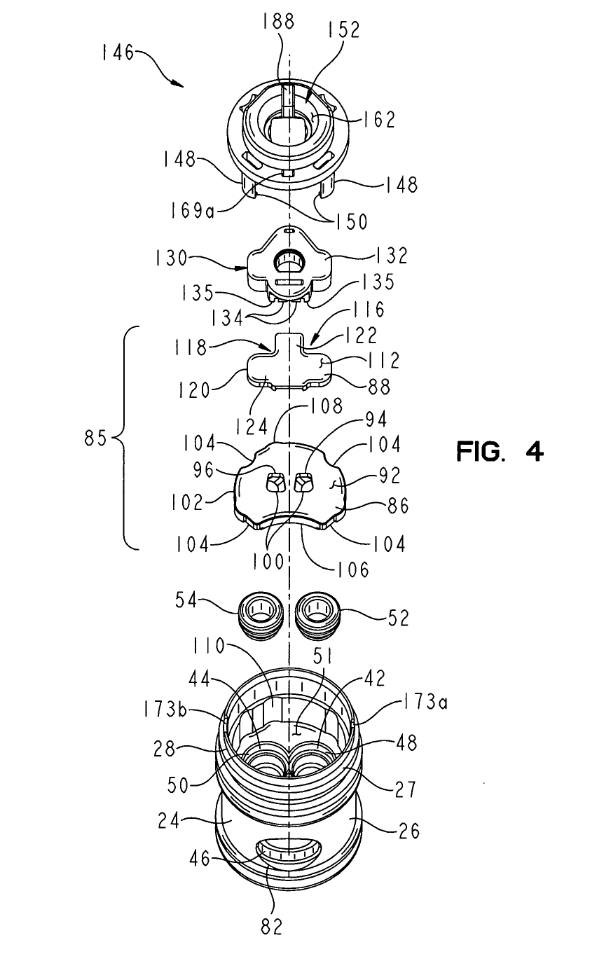

Referring now to FIGS. 5, 8, and 9, the valve body 24 includes a cold water inlet 42, a hot water inlet 44, and an outlet 46 formed within the base 26. As shown in FIG. 5, the cold water inlet 42 is positioned to the right of the hot water inlet 44, for coupling to cold water supply conduit 20 and hot water supply conduit 22 in conventional orientations (FIG. 1). In other words, the fluid control valve 10 permits the coupling of the cold water supply conduit 20 to a cold water supply (on the right) and the coupling of hot water supply conduit 22 to a hot water supply (on the left).

The cold water inlet 42 and the hot water inlet 44 each include a counterbore 48 and 50 configured to receive a valve seal, illustratively a self-biasing sealing seat 52 and 54, respectively. Each counterbore 48 and 50 extends downwardly from an upper surface 51 of the base 26. It should be appreciated that valve seals urged against the counterbores 48 and 50 by springs (not shown) may be substituted for the seats 52 and 54. Illustrative embodiment seats are shown in U.S. Pat. No. 4,700,928, the disclosure of which is expressly incorporated by reference herein.

With reference to FIGS. 5 and 9, each seat 52 and 54 is illustratively formed of a resilient material, such as an elastomer, and includes a tubular body 55 having an upper portion 56 and a lower portion 58. The upper portion 56 includes an upper flange 60 and a lower flange 62 separated by an annular gap 64. As shown in FIG. 9, an upper surface 66 of the upper flange 60 extends above the upper surface 51 of the base 26. The annular gap 64 controls the amount of flex or axial displacement permitted in response to compressive force applied to the upper flange 60. Moreover, the gap 64 serves as a built-in spring (i.e. self-biasing) such that the body 55 compresses at a uniform rate before it turns substantially solid or incompressible. The lower portion 58 of each seat 52 and 54 includes a pair of annular rings 70 and 72 configured to seal against a sealing surface 74 of respective inlet 42 and 44. More particularly, the rings 70 and 72 are radially squeezed or compressed by the sealing surfaces 74.

As shown in FIGS. 5 and 8, the outlet 46 of the valve body 24 illustratively includes an inner port 76 extending through the upper surface 51 of the base 26 and in communication with a perpendicularly extending fluid passageway 78. The fluid passageway 78 includes a first outer port 80 extending axially downwardly through a lower surface 84 of the base 26, and a second outer port 82 extending radially outwardly from the valve body 24. The cold water supply conduit 20 is fluidly coupled to the cold water inlet 42, while the hot water supply conduit 22 is fluidly coupled to the hot water inlet 44. Illustratively one or both of the outlet ports 80 and 82 are fluidly coupled to a delivery device, such as the delivery spout 16. It should be appreciated that the fluid control valve 10 may be used in connection with a wide variety of delivery devices, including hand held sprayers and pull-down spray leads.

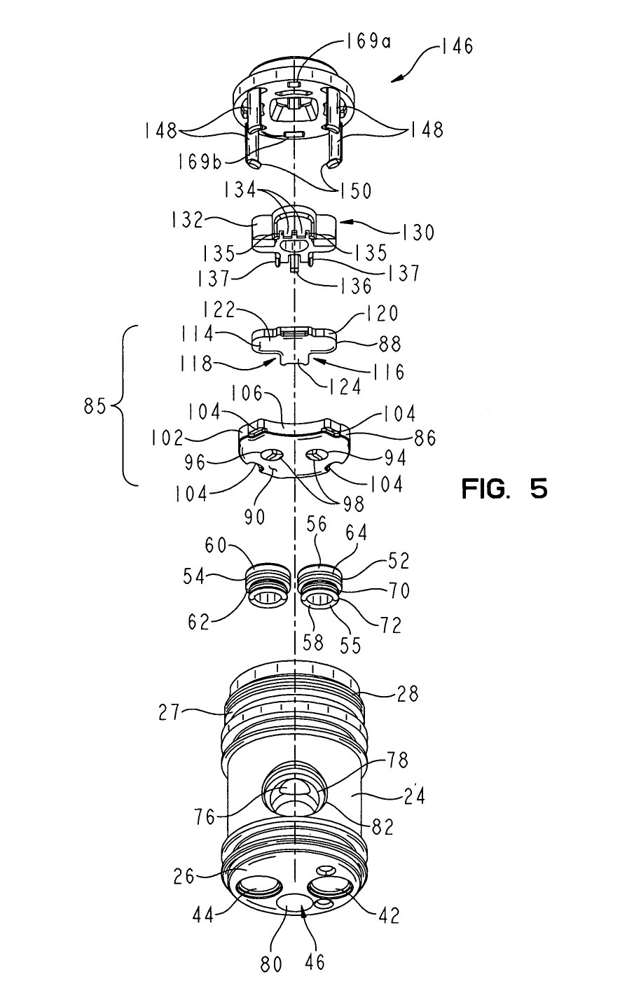

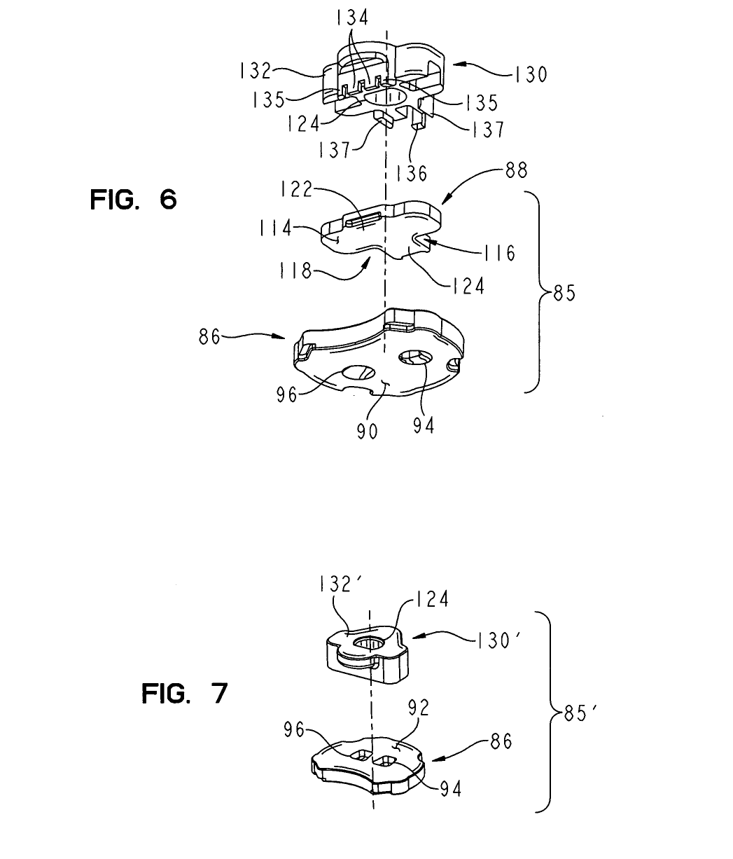

With reference to FIGS. 3-6, the flow control assembly 32 illustratively includes a valve device 85 having a bottom plate 86 and a cooperating top plate 88. The seats 52 and 54 provide a fluid seal between a lower surface 90 of the bottom plate 86 and the valve body 24. As explained in further detail herein, the seats 52 and 54 also provide a biasing effect upwardly against the bottom plate 86. In other words, the seats 52 and 54 act like springs to “hydraulically balance” the fluid control valve 10. More particularly, the seats 52 and 54 are compressed during use and are therefore urged against the bottom plate 86. The seats 52 and 54 are configured to maintain a substantially uniform force against the bottom plate 86 over the range of allowable flex defined by the gap 64. As such, the seats 52 and 54 absorb “stack up” tolerances among components of the control valve 10 and seal against the bottom plate 86 even at low water pressures.

The bottom plate 86 is substantially planar and includes lower surface 90 and upper surface 92. Illustratively, the lower surface 90 and the upper surface 92 are substantially flat to facilitate sealing therewith. In one illustrative embodiment, the bottom plate 86 is formed of a highly polished ceramic material. In a further illustrative embodiment, the bottom plate 86 is formed of alumina. A cold water opening 94 and a hot water opening 96 are formed within the bottom plate 86 and extend between the lower surface 90 and the upper surface 92. The seats 52 and 54 seal around the openings 94 and 96 at the lower surface 90 of the bottom plate 86. Illustratively, the openings 94 and 96 include a substantially cylindrical lower portion 98 which transitions into a trapezoidal shaped upper portion 100.

As shown in FIGS. 4 and 5, the outer peripheral edge 102 of the bottom plate 86 includes a plurality of coupling notches 104 formed therein. A water passage recess 106 is likewise formed in a front portion of the peripheral edge 102 of the bottom plate 86. A key tab or extension 108 is formed on the peripheral edge 102 of the bottom plate 86 and is configured to be received within a cooperating notch 110 formed within the inner surface 112 of the valve body side wall 28 (FIG. 4). Cooperation between the tab 108 and the notch 110 facilitates proper orientation of the flow control assembly 32 within the valve body 24.

The top plate 88 illustratively includes a substantially flat upper surface 112 and a substantially flat lower surface 114 to facilitate sealing therewith. Illustratively, the top plate 88 is formed of a highly polished metal, such as stainless steel. It should be appreciated that the top plate 88 may be formed of other suitable materials, such as ceramics. The top plate 88 illustratively has a T-shape defined by first and second flow control recesses 116 and 118 defining an outer peripheral control edge 120. The top plate 88 includes a base 122 extending in a first direction and an extension or arm 124 extending in a second direction perpendicular to the base 122. The top plate 88 is supported to slidably and sealingly engage the bottom plate 86, such that the outer peripheral control edge 120 is configured to control the flow of water passing through the cold water inlet 42 and the hot water inlet 44.

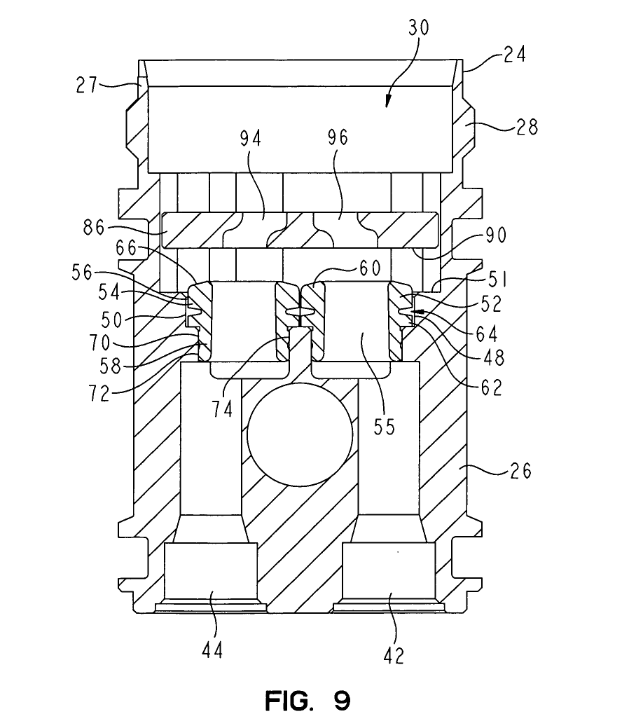

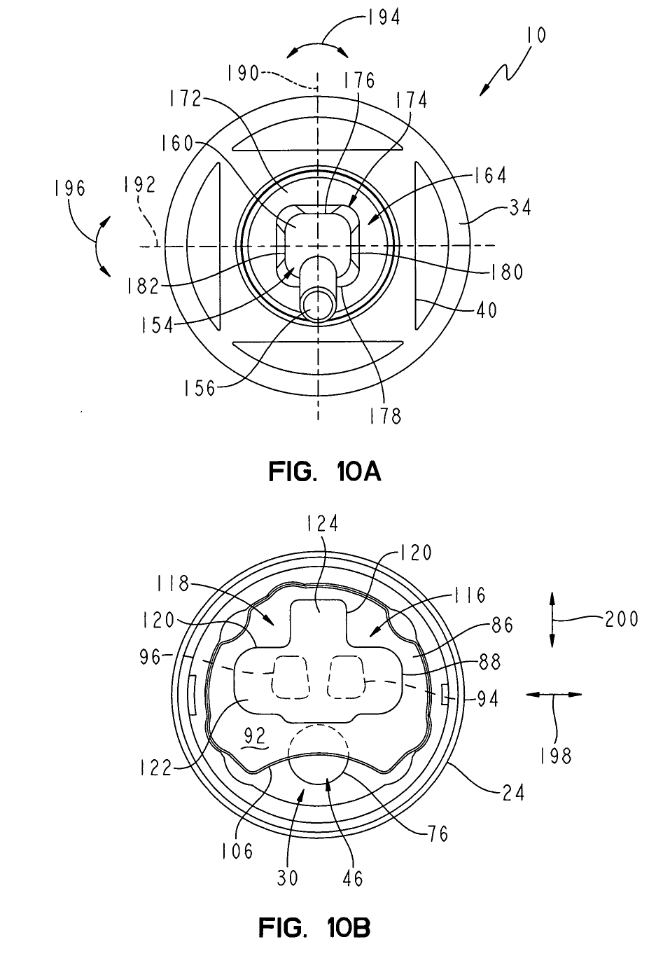

In order to be able to control the flow rate and the temperature of the water flowing from the delivery spout 16 of the faucet 12, it is necessary to be able to vary the lateral or cross-sectional flow areas of water passing through the openings 94 and 96 of the bottom plate 86 from fully open to fully closed. Illustratively, this function is performed by the manner in which the top plate 88 slides across the upper surface 92 of the bottom plate 86. As detailed herein, the relationship between the top plate 88 and the bottom plate 86 is diagrammatically illustrated for four different potential flow and temperature combinations by FIGS. 10B, 11B, 12B, and 13B.

With reference to FIGS. 4-6, a carrier 130 is operably coupled to the top plate 88 and is configured to guide the plate 88 in movement. The carrier 130 includes a body 132 having a plurality of downwardly extending retaining arms 134, 135, 136, and 137 for coupling to the top plate 88. The arms 134 and 135 couple to the base 122 of the top plate 88, while the arms 136 and 137 couple to the extension 124 of the top plate 88. The arms 134 include lips 138 configured to engage upper surface 112 of the base 122 of the top plate 88. Similarly, the arm 136 includes a lip 140 to engage upper surface 112 of the extension 124 of top plate 88. The interfit between the carrier 130 and the top plate 88 means that these two components move together as a single unit. The body 132 also includes a receiving opening 142 to receive a lower connecting portion of a spindle. The carrier 130 may be formed of a molded thermoplastic, such as Polybutylene Terephthalate (PBT).

An alternate embodiment carrier 130′ is shown in FIG. 7, wherein the top plate 88 is formed integral with the body 132. In other words, the lower surface of the top plate 88 is formed as part of the carrier 130′. In one illustrative embodiment, the carrier 130′ is formed of a thermoplastic which may be overmolded over the top plate 88. Alternatively, the bottom portion of the carrier 130′ itself may form the lower or sealing surface of the top plate 88, wherein the carrier 130′ is illustratively formed of a powdered metal or ceramic. The carrier 130′ cooperates with the bottom plate 86 to define the valve device 85′ similar to that detailed above.

A clamp member or cradle 146 is coupled to the bottom plate 86. More particularly, the cradle 146 illustratively includes a plurality of downwardly extending legs 148 having retaining lips 150 configured to couple to the bottom plate 86. A plurality of fluid openings 151 are defined between adjacent legs 148 and which provide fluid communication with the chamber 30 of the valve body 24 (FIG. 3). The cradle 146 may be formed of a thermoplastic, such as an acetal resin. The cradle 146 includes a socket 152 for receiving a spindle 154 (FIG. 3). More particularly, the spindle 154 includes a control stem 156 and a drive portion 158, and a ball 160 positioned intermediate the stem 156 and the drive portion 158. The socket 152 includes a semi-spherical inner surface 162 configured to support the ball 160. In one illustrative embodiment, the drive portion 158 and the ball 160 are formed of thermoplastic molded around the stem 156, which may be formed of a metal, such as stainless steel (FIG. 8).

A top housing 164 is operably coupled to the cradle 146 and secures the spindle 154 therebetween. The top housing 164 may be formed of a thermoplastic, such as acetal resin. A radial seal, illustratively a lip seal 165, is received intermediate the top housing 164 and the spindle 154 and is configured to seal around the ball 160 of the spindle 154. The lip seal 165 is illustratively formed of a resilient material, such as an elastomer, and illustratively includes radially spaced annular flanges or lips 166a and 166b configured to enhance sealing between the top housing 164 and the spindle 154 (FIG. 8). The bonnet nut 34 is received over the flow control assembly 32 received within the chamber 30 of the valve body 24. The bonnet nut 34 forces the top housing 164 downwardly thereby causing the bottom plate 86 to act against the bottom seats 52 and 54 which provide a reactive biasing force upwardly against the plate 86.

The top housing 164 includes a cylindrical body 170, having a pair of downwardly extending retaining fingers 167a and 167b. Each finger 167a and 167b includes a lip 168 configured to be retained by an opening 169a and 169b, respectively, formed within the cradle 146. Fingers 167a and 167b, and openings 169a and 169b, are of different sizes to facilitate proper orientation of the top housing 164 relative to the cradle 146 (FIG. 5). The body 170 further includes a pair of diametrically opposed tabs 171a and 171b configured to be received within a pair of diametrically opposed slots 173a and 173b, respectively, formed within the upper end of the cylindrical side wall 28 of valve body 24. Tab 171a and slot 173a are wider than tab 171b and slot 173b in order to facilitate proper orientation of the top housing 164 within the valve body 24.

The body 170 supports a guide member 172 having a control opening 174. The control opening 174 is shaped and contoured in order to control and limit the range of motion and the available travel directions for the control stem 156 of the spindle 154. The control opening 174 is defined by a rear wall 176, a front wall 178, a right wall 180, and a left wall 182. All four walls 176, 178, 180, and 182 are illustratively disposed at right angles to each other, such that the control opening 174 defines a rectangle. In one illustrative embodiment, the walls 176, 178, 180, and 182 are of substantially equal lengths such that the control opening 174 is substantially square. As detailed herein, the control opening 174 constrains the top plate 88 to movement within a rectangular boundary relative to the bottom plate 86. Illustratively, the control valve 10 provides for a square pattern of movement, wherein one direction of movement controls the water temperature, and another independent direction of movement controls the water flow rate.

An annular seal 184, illustratively a conventional o-ring, is supported within a groove 185 formed within the cylindrical body 170 of the top housing 164. The seal 184 provides for sealing engagement between the side wall 28 of the valve body 24 and the top housing 164.

The control stem 156 of the spindle 154 extends through the control opening 174. A pivot pin 186 extends from a side of the ball 160 of the spindle 154 and is received within a slot 188 formed in the cradle 146. The pivot pin 186 defines a first pivot axis 190 which extends perpendicular or orthogonal to a second pivot axis 192 of the ball 160. As may be appreciated, the pivot pin 186 is configured to move along and are within the slot 188 as the ball 160 rotates about the second pivot axis 192.

Since the spindle 154 includes the ball 160 supported for rotational movement within the socket 152, movement of the control stem 156 results in movement of drive portion 158 in the opposition direction. This, in turn, enables the drive portion 158 to move the top plate 88 laterally in response to movement of the control stem 156. The positioning of the drive portion 158 into opening 142 of the carrier 130 translates movement of the control stem 156 into sliding movement of the top plate 88 across the upper surface of the bottom plate 86. As the carrier 130 and, in turn, the top plate 88 move in a sliding motion, flow parameters of the water flowing from the corresponding delivery spout 16 are changed or adjusted. In other words, rotational movement of the spindle 154 causes the top plate 88 to move across the upper surface 92 of the bottom plate 86 with a sliding action. This sliding motion varies the open cross sectional area of flow openings 94 and 96. Since these two openings 94 and 96 correspond to the hot water and the cold water supply conduits 20 and 22, a first direction of rotational movement 194 of the control stem 156 about the first axis 190, which corresponds to the axial center line of the pivot pin 186, controls a first fluid flow parameter, i.e. the water temperature. More particularly, rotational movement 194 of the control stem 156 about the first axis 190, results in sliding movement 198 of the top plate 88, within a first range of movement between a cold-flow position and a hot-flow position, relative to the bottom plate 86.

A second direction of movement 196 of the control stem 156 is in a rotational direction about the second axis 192, orthogonal to the first axis 190. As detailed above, the spindle 154 is able to rotate as an integral unit about the pivot pin 186. The spindle 154 is likewise able to rotate as an integral unit about the second axis 192 extending perpendicular to the pivot pin 186. Since the second axis 192 is located between control stem 156 and drive portion 158, movement of the stem 156 in a first direction results in movement of the drive portion 158 in the opposite direction. The positioning of the drive portion 158 into opening 142 of the carrier 130 translates movement of the control stem 156 into sliding movement of the top plate 88 across the upper surface of the bottom plate 86. Movement of stem in this direction 196 (i.e., rotational travel about second axis) is used to adjust the flow rate of the exiting flow of water between a full-flow-on condition and an off (no flow) condition. More particularly, rotational movement 196 of the control stem 156 about the second axis 192 results in sliding movement 200 of the top plate 88 relative to the bottom plate 86 within a second range of movement between a full-flow-on condition and an off (no flow) condition. The flow rate is adjusted by the degree or extent that openings 94 and 96 are opened or closed. Full flow is achieved when a predetermined portion, illustratively the majority, of the openings 94 and 96 are uncovered by top plate 88. The off condition is achieved when top plate 88 is moved so as to completely cover (i.e., close) the openings 94 and 96.

The two rotational directions movement of spindle 154, the first 194 about the pivot pin 186 and the second 196 about the second axis 192 perpendicular to the pivot pin 186, are independent from each other. More particularly once the desired temperature is selected by movement of the spindle 154 about the pivot pin 186, the flow can be adjusted without changing the selected temperature setting. This means that the control valve 10 includes a temperature memory capability by enabling water temperature to be independently adjusted relative to the flow rate and by the design of two independent spindle movements. Similarly, the temperature can be adjusted without changing the selected flow setting. In other words, the top plate 88 is configured to control the temperature of the water and the flow rate of the water independently of each other throughout both the first range of movement (about the first axis 190) and the second range of movement (about the second axis 192). As such, the top plate 88 is movable between the cold-flow position and the hot-flow position at any location from the off position to the full-flow-on position.

In the illustrative embodiment, cooperation between the control stem 156 and the control opening 174 of the top housing 164 provides the fluid control valve 10 with a square pattern of movement involving two independent axes 190 and 192 of rotation. As stated above, one direction controls the temperature of the water, while the other direction controls the flow rate. Since these two rotational axes 190 and 192 are independent of each other, the valve 10 includes the temperature memory feature. Further, rotation of the control stem 156 about the two axes 190 and 192 of rotation translates into sliding movement, in both directions 198 and 200, of top plate 88 across the upper surface of the bottom plate 86.

With reference now to FIGS. 10A-13B, the positioning of top plate 88 relative to bottom plate 86 for four different flow and temperature combinations (i.e., flow control valve positions), is diagrammatically illustrated. More particularly, FIGS. 10A, 11A, 12A, and 13A are all top plan views of the control stem 156 illustrating its relative positioning within the control opening 174 of the guide member 172. FIGS. 10B, 11B, 12B, and 13B are all diagrammatic top plan views taken from above the top plate 88 illustrating water flow arrangements corresponding to relative positions of the control stem 156 shown in FIGS. 10A, 11A, 12A, and 13A, respectively.

As detailed herein, the bottom plate 86 includes two openings 94 and 96 which are selectively covered by the top plate 88 and thereby selectively sealed from communication with the chamber 30. Cold water opening 94 corresponds to the cold water supply conduit 20 (to the right in FIG. 1), while hot water opening 96 corresponds to the hot water supply conduit 22 (to the left in FIG. 1). Further, cold water opening 94 is positioned to the right of hot water opening 96 such that, when water is flowing, movement of the control stem 156 to the right increases the flow of cold water, and movement of the control stem 156 to the left increase the flow of hot water. Recess 106 is formed within the outer edge 102 of the bottom plate 86 to facilitate communication with the outlet 46. The openings 94 and 96 are shaped and contoured for the desired flow cross sectional geometry based upon the overlap of the top plate 88 on the bottom plate 86.

As shown in FIGS. 10A and 10B, when the control stem 156 abuts the front wall 178 of the control opening 174, it causes the control valve 10 to be in an off condition. More particularly, the drive portion 158 is rotated about the first axis 190 in a direction opposite the control stem 156. More particularly, the top plate 88 is moved rearwardly within the valve chamber 30 such that it completely overlaps the openings 94 and 96 of the bottom plate 86. Neither hot water nor cold water is able to flow from the openings 94 and 96 in order to reach outlet 46 by flowing through chamber 30 of the valve body 24.

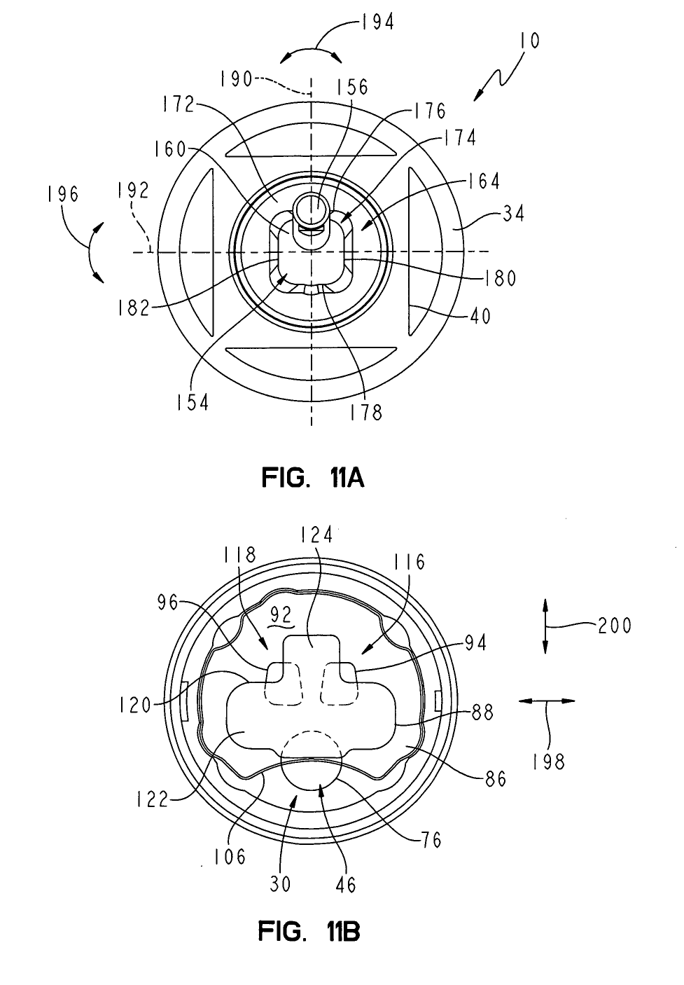

Turning now to FIGS. 11A and 11B, movement of the control stem 156 in a rearward direction such that it abuts the rear wall 176 causes the control valve 10 to be in a full-flow-on condition. More particularly, the top plate 88 is moved forward by the drive portion 158 of the spindle 156 to expose openings 94 and 96 to the chamber 30. The recesses 116 and 118 formed within peripheral control edge 120 of the top plate 88 overlap the openings 94 and 96 to the maximum extent permissible given the structural characteristics of the flow control assembly 32. It should be appreciated that the geometry of the plates 86 and 88, and more particularly the control edge 20, may be varied as needed to change the amount of flow desired in the full-flow-on condition. Illustratively, the uncovered cross-sectional area of openings 94 and 96 is at least as large as the smallest cross-sectional area of the water outlet 46 so that the fluid control valve 10 is considered to be in the full-flow-on condition.

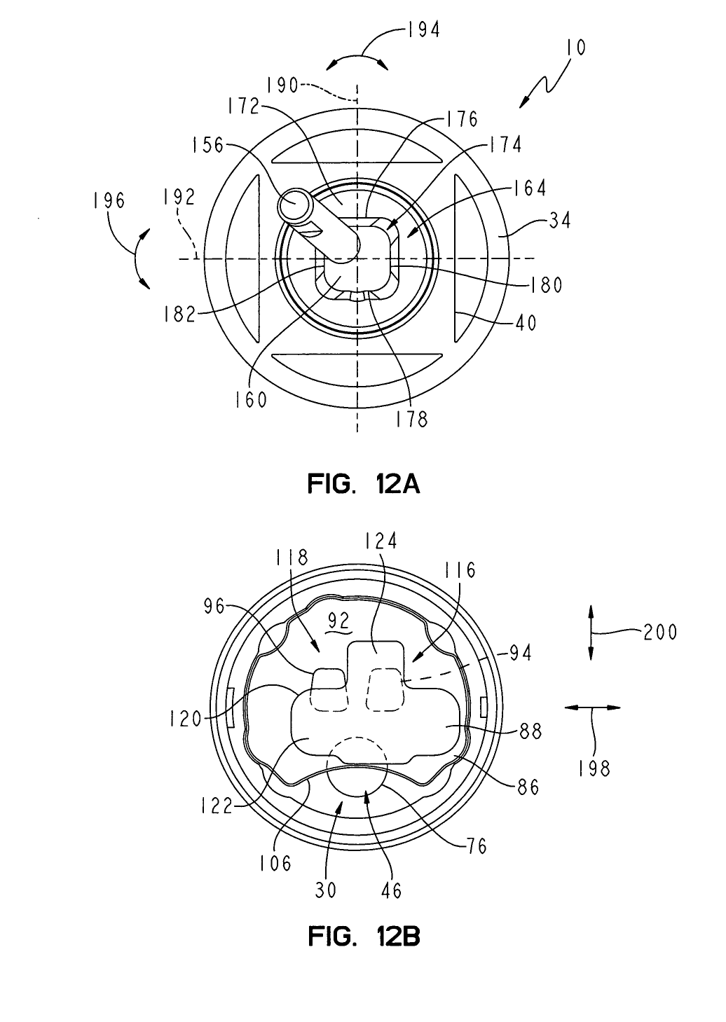

FIGS. 12A and 12B illustrate the control stem 156 abutting the left wall 182 of the control opening 174 adjacent the rear wall 176, causing the control valve 10 to be in a full-on hot-flow position. More particularly, the top plate 88 is moved to the right by the drive portion 158 of the spindle 156 to expose the hot water opening 96 to the chamber 30 and to seal the cold water opening 94 therefrom. More particularly, the top plate 88 completely covers cold water opening 94, while the top plate 88 uncovers a majority of the hot water opening 96. As such, hot water from the hot water supply conduit 22 passes through the opening 96, through the chamber 30, and to the outlet 46. Again, the uncovered cross sectional area of the hot water opening 96 is illustratively at least as large as the smallest cross-sectional area of the outlet 46, since the fluid control valve 10 is considered to be in a full on condition.

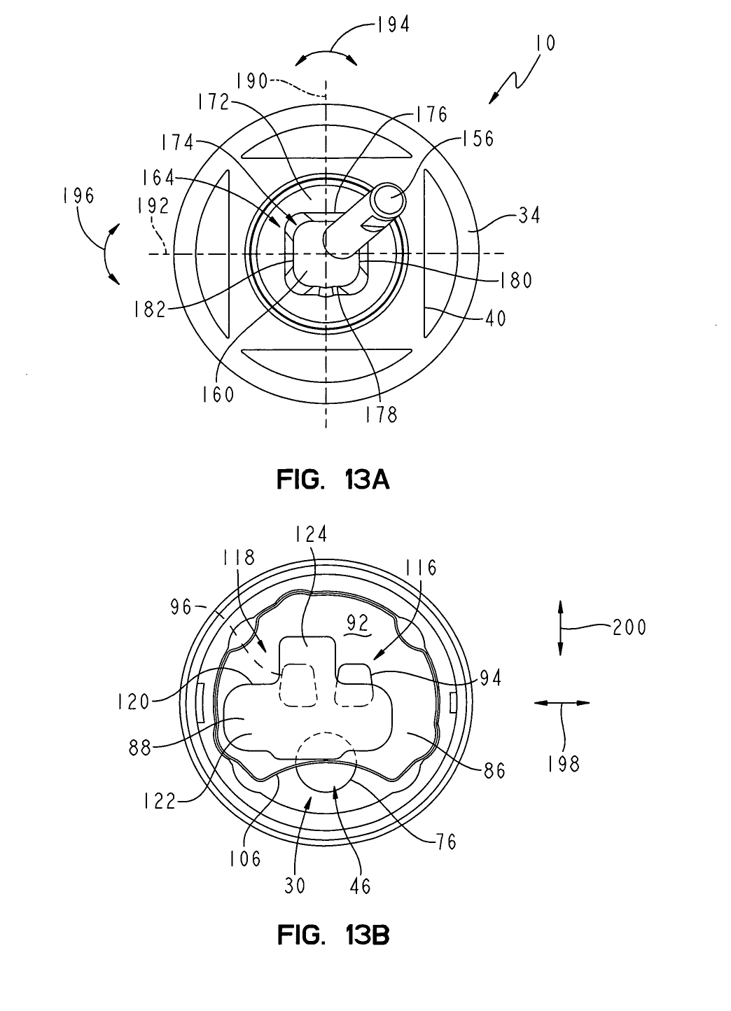

Referring now to FIGS. 13A and 13B, the control stem 156 is illustrated in abutment with the right wall 180 of the control opening 174 adjacent the rear wall 176, causing the control valve 10 to be in a full-on cold-flow position. More particularly, the top plate 88 is moved to the left by the drive portion 158 of the spindle 156 to expose the cold water opening 94 to the chamber 30 and to seal the hot water opening 96 therefrom. In other words, the hot water opening 96 is completely covered while the cold water opening 94 is uncovered. As such, cold water from the cold water supply conduit 20 passes through the opening 94, through the chamber 30, and to the outlet 46. Again, the uncovered cross-sectional area of the cold water opening 94 is illustratively at least as large as the smallest cross-sectional area of the outlet 46, since the fluid control valve 10 is considered to be in a full-on condition.

FIGS. 10A-13B are examples of only some of the various positions achievable by the illustrative flow control assembly 32. It should be understood that additional flow and temperature combinations may be achieved through various positioning of the top plate 88 relative to the bottom plate 86 through operation of the spindle 154.

Although the invention has been described in detail with reference to certain preferred embodiments, variations and modifications exist within the spirit and scope of the invention as described and defined in the following claims.

1. A fluid control valve comprising:
a valve body defining a chamber and a plurality of passageways in fluid communication with the chamber;
a valve device positioned within the chamber, the valve device including a movable plate having an outer peripheral edge configured to control the flow of fluid through the plurality of passageways; and
a movable spindle operably coupled to the valve device, the spindle being configured to rotate in a first direction about a first axis for moving the movable plate within a first range of movement to control a first fluid flow parameter and to rotate in a second direction about a second axis for moving the movable plate within a second range of movement to control a second fluid flow parameter, the first direction being distinct from the second direction, the first axis being orthogonal to the second axis, and the movable plate being configured to control the first fluid flow parameter and the second fluid flow parameter independently of each other throughout both the first range of movement and the second range of movement.

2. The fluid control valve of claim 1, further comprising a cradle including a socket supported above the movable plate, the spindle including a ball received within the socket.

3. The fluid control valve of claim 2, wherein:
the valve device further includes a bottom plate;
the cradle includes a plurality of legs coupling to the bottom plate, the plurality of legs defining openings therebetween in fluid communication with the chamber of the valve body; and
the movable plate is positioned intermediate the cradle, the bottom plate, and the plurality of legs.

4. The fluid control valve of claim 2, further comprising:
an upper housing including a guide member having a control opening extending therethrough;
a radial seal positioned intermediate the upper housing and ball of the spindle; and
wherein the spindle includes a control stem passing through the control opening.

5. The fluid control valve of claim 4, wherein the control opening includes four walls of substantially equal length defining a square, the four walls including a rear wall, a front wall, a right wall, and a left wall, the valve device being in an off position when the stem abuts the front wall of the control opening, the valve device being in a full-flow-on position when the stem abuts the rear wall of the control opening, the valve device being in a cold-flow position when the stem abuts the right wall of the control opening, and the valve device being in a hot-flow position when the stem abuts the left wall of the control opening.

6. The fluid control valve of claim 1, further comprising a carrier operably coupling the spindle and the movable plate.

7. The fluid control valve of claim 1, wherein the first fluid parameter is the temperature of the fluid.

8. The fluid control valve of claim 7, wherein the second fluid parameter is the flow rate of the fluid.

9. The fluid control valve of claim 8, wherein the first range of movement is between a cold-flow position and a hot-flow position, the second range of movement is between an off position and a full-flow-on position, the movable plate being movable between the cold-flow position and the hot-flow position for any location from the off position to the full-flow-on position.

10. The fluid control valve of claim 1, wherein the valve device further includes a bottom plate received within the chamber and having a stationary surface, and the movable plate is positioned on the stationary surface and is configured to move across the stationary surface.

11. The fluid control valve of claim 10, further comprising a plurality of seats positioned intermediate the valve body and the bottom plate, the plurality of seats being configured to bias the bottom plate away from the valve body.

12. The fluid control valve of claim 10, wherein the movable plate is configured to move in a sliding motion across the stationary surface in a first control direction in response to movement of the movable spindle in the first direction.

13. The fluid control valve of claim 12, wherein the movable plate is configured to move in a sliding motion across the stationary surface in a second control direction in response to movement of the movable spindle in the second direction.

14. The fluid control valve of claim 1, further comprising a self-biasing seat positioned intermediate the valve body and the valve device.

15. A fluid control valve comprising:
a valve body defining a chamber and a plurality of passageways in fluid communication with the chamber;
a valve device positioned within the chamber, the valve device including a movable plate having an outer peripheral edge configured to control the flow of fluid through the plurality of passageways;
a control stem operably coupled to the movable plate and extending upwardly therefrom;
an upper housing including a guide member having a control opening through which the control stem passes, the control opening including four walls disposed at substantially right angles to each other and defining a rectangle, the four walls including a rear wall, a front wall, a right wall, and a left wall; and
wherein the valve device is in an off position when the control stem abuts the front wall of the control opening, the valve device is in a full-flow-on position when the control stem abuts the rear wall of the control opening, the valve device is in a cold-flow position when the control stem abuts the right wall of the control opening, and the valve device is in a hot-flow position when the control stem abuts the left wall of the control opening.

16. The fluid control valve of claim 15, wherein the control stem is supported for rotation in a first direction about a first axis for moving the movable plate to control a first fluid flow parameter, and for rotation in a second direction about a second axis for moving the movable plate to control a second fluid flow parameter, the first direction being distinct from the second direction, and the first axis being orthogonal to the second axis.

17. The fluid control valve of claim 16, further comprising a cradle including a socket supported above the movable plate, and a ball operably coupled to the control stem and received within the socket.

18. The fluid control valve of claim 17, wherein:
the valve device further includes a bottom plate;
the cradle is coupled to the bottom plate, and includes a plurality of openings in fluid communication with the chamber of the valve body; and
the movable plate is positioned intermediate the cradle, the bottom plate, and the openings.

19. The fluid control valve of claim 17, further comprising a radial seal positioned intermediate the upper housing and ball of the spindle.

20. The fluid control valve of claim 15, wherein the valve device further includes a bottom plate received within the chamber and having a stationary surface, and the movable plate is positioned on the stationary surface and is configured to move across the stationary surface.

21. The fluid control valve of claim 20, further comprising a plurality of seats positioned intermediate the valve body and the bottom plate, the plurality of seats being configured to bias the bottom plate away from the valve body.

22. The fluid control valve of claim 20, wherein the movable plate is configured to move in a sliding motion across the stationary surface in a first control direction in response to movement of the control stem in the first direction.

23. The fluid control valve of claim 22, wherein the movable plate is configured to move in a sliding motion across the stationary surface in a second control direction in response to movement of the control stem in the second direction.

24. A fluid control valve comprising:
a valve body defining a chamber, a hot water inlet, a cold water inlet, and an outlet;
a bottom plate received within the chamber and including a hot water opening in fluid communication with the hot water inlet, and a cold water opening in fluid communication with the cold water inlet;
a top plate received within the chamber of the valve body, the top plate including an upper surface and a lower surface, the lower surface positioned in engagement with the upper surface of the bottom plate, the top plate configured to provide selective fluid communication between the hot water opening and the chamber, and the cold water opening and the chamber, such that water flowing through the hot water opening and the cold water opening is discharged to the outlet of the valve body by passing through the chamber; and
a movable spindle operably coupled to the top plate, the spindle being configured to rotate about a first axis to cause sliding movement of the top plate relative to the bottom plate in a first direction, and to rotate about a second axis to cause sliding movement of the top plate relative to the bottom plate in a second direction, the first axis being orthogonal to the second axis, and the top plate being constrained to move within a rectangular boundary relative to the bottom plate.

25. The fluid control valve of 24, wherein the top plate includes a peripheral control edge in fluid communication with the chamber of the valve body, movement of the control edge in the first direction controlling a first fluid flow parameter, and movement of the control edge in the second direction controlling a second fluid flow parameter.

26. The fluid control valve of claim 25, wherein the first fluid parameter is the temperature of the fluid.

27. The fluid control valve of claim 26, wherein the second fluid parameter is the flow rate of the fluid.

28. The fluid control valve of 24, wherein the spindle includes a control stem defining a longitudinal axis, the first and second axes being orthogonal to the longitudinal axis.

29. The fluid control valve of claim 24, further comprising a cradle including a socket supported above the top plate, the spindle including a ball received within the socket.

30. The fluid control valve of claim 29, wherein the cradle includes a plurality of legs coupling to the bottom plate, the plurality of legs defining openings therebetween in fluid communication with the chamber of the valve body, the top plate being positioned intermediate the cradle, the bottom plate, and the plurality of legs.

31. The fluid control valve of claim 29, further comprising:
a top housing including a guide member having a control opening extending therethrough;
a lip seal positioned intermediate the top housing and ball of the spindle; and
wherein the spindle includes a control stem passing through the control opening.

32. The fluid control valve of claim 24, further comprising a plurality of seats positioned intermediate the valve body and the bottom plate, the plurality of seats being configured to bias the bottom plate away from the valve body.

33. The fluid control valve of claim 24, wherein the spindle is configured to rotate about the first axis for moving the top plate within a first range of movement to control a first fluid flow parameter and to rotate about the second axis for moving the top plate within a second range of movement to control a second fluid flow parameter, and the top plate is configured to control the first fluid flow parameter and the second fluid flow parameter independently of each other throughout both the first range of movement and the second range of movement.
